(19) United States
(12) Patent Application Publication
(10) Pub. No.: US 2004/0029695 A1
(43) Pub. Date: Feb. 12, 2004

(54) Device for adjusting a folding blade and folder having the device

(76) Inventor: Klaus-Peter Schreiber, Asperg (DE)

Correspondence Address: LERNER AND GREENBERG, P.A., POST OFFICE BOX 2480, HOLLYWOOD, FL, 33022-2480, US

(21) Appl. No.: 10/611,082

(22) Filed: Jul. 1, 2003

(30) Foreign Application Priority Data
Jul. 1, 2002 (DE) 102 29 468.2

(51) Int. Cl. B31B 47/00

(52) U.S. Cl. 493/478

(57) ABSTRACT

A device for adjusting a folding blade has a push rod assembly with which the folding blade is coupled for producing a vertical movement of the folding blade. The push rod assembly has an inner push rod, an outer push rod and a positioning device for adjusting a position of the outer push rod relative to the inner push rod. The positioning device is firmly secured to a frame relative to at least one of the push rods. A folder includes at least one folding unit with a folding blade and the device for adjusting the folding blade.

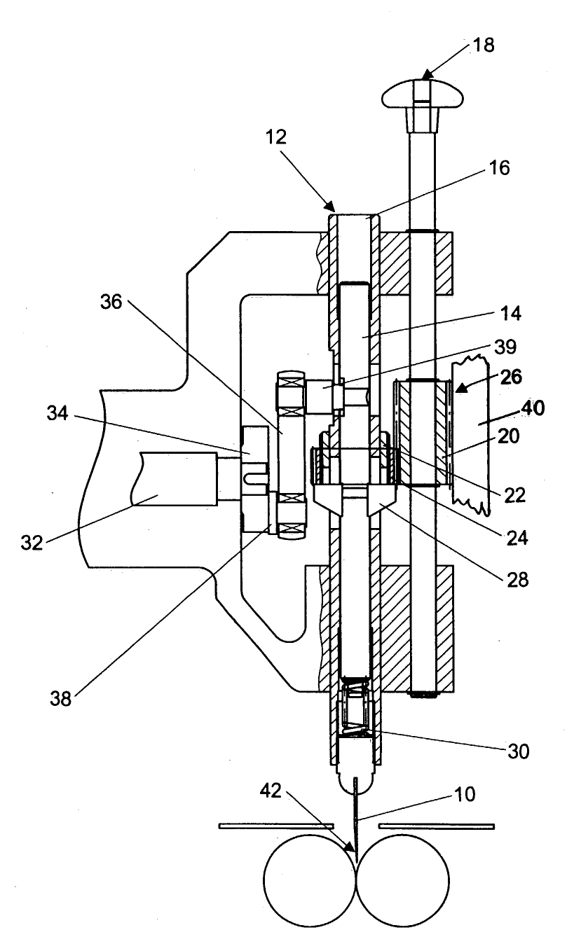

### BACKGROUND OF THE INVENTION

1. Field of the Invention

The invention relates to a device for adjusting a folding blade having a push rod with which the folding blade is coupled for producing a vertical movement of the folding blade. The invention also relates to a folder having the device.

During the production of folded products, such as folded paper sheets or signatures, it is necessary to position the folding blades which are used during the folding process. It is also necessary that a possibility for adjustment during operation be provided in order to also be able to react to changing circumstances during operation of the folder. For that purpose, in particular, the insertion depth of the folding blade must be variable. That is because, inserting the folding blade too deeply can damage the product to be folded, whereas not inserting it far enough results in an unsatisfactory execution of the folding process, because the folded product would then not be transferred to the folding rollers in a controlled and slip-free manner.

German Patent DE 30 19 003 C2 discloses a device for adjusting the insertion depth of the folding blade in an infinitely variable manner. In that regard, the insertion depth is controlled by changing the axis of rotation of the drive element for the pushing movement of the folding blade. In order to achieve that change, a proposal is made that the axis of rotation of a drive wheel coupled with the folding blade be moved into a desired position with the aid of an outer stop since the outer stop is accessible even during the operation of the folder, positioning is thus also possible during operation.

Furthermore, German Patent DE 30 27 342 C2, corresponding to U.S. No. Pat. No. 4,388,073,discloses a device for adjusting a folding blade, which permits adjustment of the folding blade even when the folder is operating. In that regard, the folding blade is fitted or applied to a blade bolt which is fastened to a housing. In order to adjust the insertion depth of the folding blade, a vertical guide plate is provided, along which the housing can be positioned and guided with the aid of a setscrew.

### SUMMARY OF THE INVENTION

It is accordingly an object of the invention to provide a device for adjusting a folding blade and a folder having the device, which overcome the hereinafore-mentioned disadvantages of the heretofore-known devices of this general type and with which an adjustment of a folding blade can be performed while a folding process is taking place.

With the foregoing and other objects in view, there is provided, in accordance with the invention, a device for adjusting a folding blade. The device comprises a push-rod assembly with which the folding blade is coupled for producing a vertical movement of the folding blade. The push-rod assembly includes an inner push rod, an outer push rod, and a positioning device for adjusting the position of the outer push rod relative to the inner push rod. The positioning device is firmly secured to a frame which is fixed relative to at least one of the outer and the inner push rods.

In accordance with another feature of the invention, the positioning device includes a gearwheel and a pinion meshingly engaging with one another.

In accordance with a further feature of the invention, the gearwheel is formed with an internal thread, and is supported on a stop.

In accordance with an added feature of the invention, the folding-blade adjusting device further includes a threaded sleeve provided on the outer push rod. The threaded sleeve is externally threaded and the gearwheel is positioned so that the internal thread thereof engages in the external thread of the threaded sleeve for converting a rotational movement of the gearwheel into a vertical movement of the outer push rod.

In accordance with an additional feature of the invention, the folding-blade adjusting device further includes a spindle and/or a motorized drive for turning the pinion.

In accordance with yet another feature of the invention, the folding-blade adjusting device further includes a compression spring provided at a lower end of the inner push rod for pressing the outer push rod, relative to the inner push rod, into a defined end position.

With the objects of the invention in view, there is also provided a folding machine or folder, comprising at least one folding unit with a folding blade. The folding blade has a device for adjusting the folding blade. The folding-blade adjusting device includes a push-rod assembly with which the folding blade is coupled for producing a vertical movement of the folding blade. The push-rod assembly further includes an inner push rod, an outer push rod, and a positioning device for adjusting the position of the outer push rod relative to the inner push rod. The positioning device is firmly secured to a frame which is fixed relative to at least one of the outer and the inner push rods.

Thus, according to the invention, a push-rod assembly of bipartite construction, namely having an inner push rod and an outer push rod, is provided. The folding blade is coupled with the push rod. Positioning of the folding blade is effected with the aid of a device which adjusts the position of the outer push rod relative to the inner push rod. The positioning device is firmly attached to a fixed frame, so that the positioning device does not follow the movement of the folding blade and of the outer push rod.

With this positioning device, it is possible to adjust the folding blade with regard to the insertion depth thereof, without having to reduce the machine speed, even during the performance of the folding process. Since only the position of the inner push rod in relation to the outer push rod has to be changed, it is also unnecessary to move any large masses, so that the adjustment can be effected quite simply. This considerably simplifies servicing or operating while simultaneously increasing the effective performance of the folding machine or folder. Automatic adjustment and correction or presetting which is necessary for certain paper types, can also be performed if the relative position between the inner push rod and the outer push rod is changed by machine.

In a particularly preferred embodiment of the invention, the inner push rod is positioned relative to the outer push rod with the aid of a gearwheel pair. In this regard, the first gearwheel, in particular a pinion, is driven with the aid of a suitable device. The rotation of this gearwheel is transmitted to a second gearwheel which has an internal thread. The internal thread of this second gearwheel is operatively connected to a threaded sleeve formed with an external thread. The threaded sleeve is fastened onto the outer push rod. The second gearwheel having the internal thread rests on a stop which is firmly connected to the inner push rod. With the aid of this configuration, every rotation of the second gearwheel is transmitted to the outer push rod via the internal thread of the second gearwheel. The stop, which is firmly connected to the inner push rod, effects a relative movement between the outer push rod and the inner push rod and, thereby, a change in the position of the folding blade.

An exact and fine relative movement between the outer push rod and the inner push rod can be produced if the internal thread of the second gearwheel and the external thread of the threaded sleeve are configured as fine threads. In a corresponding manner, the height of the folding blade can be adjusted very simply, exactly and in an infinitely variable manner.

Other features which are considered as characteristic for the invention are set forth in the appended claims.

Although the invention is illustrated and described herein as embodied in a device for adjusting a folding blade and a folder having the device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The FIGURE of the drawings is a diagrammatic, partly broken-away and partly sectional, side elevational view of an adjusting device according to the invention.

### DESCRIPTION OF THE PREFERRED EMBODIMENTS

Referring now in detail to the single FIGURE of the drawings, there is seen a partly sectional illustration of a device according to the invention, for adjusting a folding blade. The device has a drive shaft 32 which is connected to an entrainer or driver disc 34. A thrust crank 36 is connected to the drive shaft 32 via a first joint pin 38. The thrust crank 36 is, in turn, firmly connected to an inner push rod 14 via a second joint pin 39. This drive configuration converts, via the thrust crank 36, a rotational movement of the drive shaft 32 into a vertical translational movement of the inner push rod 14. The inner push rod 14 is coupled with an outer push rod 16 via a stop 28 and a compression spring 30. Therefore, this stroke is transmitted to the outer push rod 16, so that a push rod assembly 12, including the inner and outer push rods 14, 16, is moved vertically. Vertical movement of a folding blade 10, which is connected to the outer push rod 16 and is necessary for folding a folded product, is thereby produced. The push rod assembly 12 having the outer push rod 16 and the inner push rod 14 is thus provided according to the invention.

Accordingly, the drive shaft 32, the entrainer or driver disc 34, the thrust crank 36, the stop 28 and the inner push rod 14 are firmly connected to one another via the two joint pins 38 and 39. The outer push rod 16, as well as a threaded sleeve 22 having an external thread, and the folding blade 10, together form a rigid system.

In this configuration, adjustment in height of the folding blade 10, i.e., a change in a maximum insertion position of the folding blade 10 into a roller nip 42, is achieved by producing a movement of the outer push rod 16 relative to the inner push rod 14.

The relative movement between the outer push rod 16 and the inner push rod 14 can be changed by a mechanical or manual positioning device 26 of the push rod assembly 12. This can be achieved, for example, by manually or mechanically rotating a spindle 18 provided with a pinion 20. The rotational movement of the spindle 18 is transferred via the pinion 20 to a gearwheel 24 which is in engagement with the pinion 20. The gearwheel 24 is formed with an internal thread which, in turn, is operatively connected to the external thread of the threaded sleeve 22. The threaded sleeve 22 is fastened to the outer push rod 16. Moreover, as the gearwheel 24 rests, i.e. is supported, on the stop 28, the outer push rod 16 is moved upwardly or downwardly in accordance with the rotation of the gearwheel 24 and in accordance with the pitch of the thread of the threaded sleeve 22. The folding blade 10 and the outer push rod 16 form a rigid unit. As a consequence of the positional change of the outer push rod 16, the position of the folding blade 10 is also changed. It is thereby possible to adjust the position of the folding blade 10 via rotation of the spindle 18. In order to be able to move the folding blade 10 into a defined end position, a compression spring 30 is preferably provided at the end of the inner push rod 14 which faces the folding blade 10. The compression spring 30 serves for fixing the outer push rod 16, the threaded sleeve 22 and, accordingly, the folding blade 10 in a defined end position. The positioning device 26 is firmly secured to a fixed frame 40 relative to at least one of the push rods 14, 16, so that the positioning device does not follow the movement of the folding blade and of the outer push rod.

I claim:

1. A device for adjusting a folding blade, the device comprising:
a push-rod assembly coupled to the folding blade for producing a vertical movement of the folding blade, said push-rod assembly including an inner push rod, an outer push rod, and a positioning device for adjusting a position of said outer push rod relative to said inner push rod, said positioning device being firmly secured to a frame relative to at least one of said push rods.

2. The folding-blade adjusting device according to claim 1, wherein said positioning device includes a gearwheel and a pinion meshing in engagement with one another.

3. The folding-blade adjusting device according to claim 2, wherein said gearwheel is formed with an internal thread and is supported on a stop.

4. The folding-blade adjusting device according to claim 3, further comprising a threaded sleeve provided on said outer push rod, said threaded sleeve being externally threaded, and said gearwheel being positioned with said internal thread thereof engaging in said external thread of said threaded sleeve for converting a rotational movement of said gearwheel into a vertical movement of said outer push rod.

5. The folding-blade adjusting device according to claim 1, further comprising a spindle for turning said pinion.

6. The folding-blade adjusting device according to claim 1, further comprising a motorized drive for turning said pinion.

7. The folding-blade adjusting device according to claim 1, further comprising a spindle and a motorized drive for turning said pinion.

8. The folding-blade adjusting device according to claim 1, further comprising a compression spring provided at a lower end of said inner push rod for pressing said outer push rod, relative to said inner push rod, into a defined end position.

9. A folder, comprising:
at least one folding unit with a frame and a folding blade; and
a device for adjusting said folding blade, said device including a push-rod assembly coupled to said folding blade for producing a vertical movement of said folding blade, said push-rod assembly including an inner push rod, an outer push rod, and a positioning device for adjusting a position of said outer push rod relative to said inner push rod, said positioning device being firmly secured to said frame relative to at least one of said push rods.
